(19) United States
(12) Patent Application Publication
(10) Pub. No.: US 2009/0006657 A1
(43) Pub. Date: Jan. 1, 2009

(54) Enabling consecutive command message transmission to different devices

(76) Inventors: Asad Azam, Penang (MY); Eng Hun Ooi, Penang (MY); Soon Seng Seh, Penang (MY)

Correspondence Address: TROP PRUNER & HU, PC, 1616 S. VOSS ROAD, SUITE 750, HOUSTON, TX, 77057-2631, US

(21) Appl. No.: 11/821,874

(22) Filed: Jun. 26, 2007

(51) Int. Cl. G06F 3/00

(52) U.S. Cl. 710/5

(57) ABSTRACT

In one embodiment, the present invention includes a method for transmitting a frame information structure (FIS) message from a host controller or receiving a FIS message at the host controller, transmitting a synchronization signal from the host controller to a port multiplier coupled to the host controller via a link and sustaining a transmit ready signal from the host controller to the port multiplier to thereby lock the link between the host controller and the port multiplier after sending the synchronization signal, and transmitting multiple command FIS messages from the host controller to the port multiplier in a back-to-back manner, where the back-to-back command FIS messages are directed to different devices. Other embodiments are described and claimed.

### BACKGROUND

A Port Multiplier (PM) device allows a single active serial advanced technology advancement (SATA) host port to communicate with up to 15 attached devices, providing a cost effective method for multiple drives to be attached to the single host port and making it transparent for the attached drives. A Port Multiplier can accommodate both Command Based Switching (CBS) and frame information structure (FIS)-Based Switching (FBS). CBS is similar to having a single device attached to the host port, where commands tagged with a Port Multiplier Port (PMP) number are sent to the device one at a time. FBS mode however allows the host to establish communication with multiple devices simultaneously, thus maximizing link bandwidth utilization by allowing high performance storage connections to multiple drives.

In FBS mode, multiple PMPs can have commands outstanding. Native command queuing (NCQ) allows reordering of outstanding commands to reduce mechanical overhead in SATA hard disk drives for optimal performance. Therefore, if one command at a time is sent to the device then the drive will have only one outstanding command at a time and only one command at a time is queued, which inhibits any command queue re-ordering capability and thus all the benefits of the NCQ are lost.

### BRIEF DESCRIPTION OF THE DRAWINGS

FIG. 1 is a block diagram of a system in accordance with one embodiment of the present invention.

FIG. 2 is a block diagram of a buffer manager in accordance with one embodiment of the present invention.

FIG. 3 is a more detailed block diagram of a buffer manager in accordance with one embodiment of the present invention.

### DETAILED DESCRIPTION

Embodiments may provide for maximum performance by sending multiple back-to-back commands to multiple devices attached to a Port Multiplier (PM). In various embodiments, idle bus bandwidth in FIS Based Switching (FBS) mode may be fully utilized by dispatching commands to multiple Port Multiplier Ports (PMPs) (i.e., multiple devices) behind a PM. By queuing multiple commands even in FBS mode with multiple active devices, greater performance gains may be realized by taking full advantage of Native Command Queuing (NCQ). By providing such enqueuing, a hard disk drive's internal command queue may be prevented from becoming empty by replenishing the command queue as fast as possible for all the active devices, thus utilizing the bus bandwidth to maximum.

To implement embodiments of the present invention, a host may lock the SATA link by sending one synchronization (SYNC) primitive to the device and sustaining a transmit ready (XRDY) primitive. More specifically, via such link locking in FBS mode back-to-back Command FIS (CFIS) transmissions to multiple devices behind the Port Multiplier may be performed. This algorithm takes advantage of the fact that the transmission time for each CFIS is relatively very short as compared to the response time from the device. The aggressive bus ownership with 1-SYNC locking and transmission is needed because hard disk drives may take several micro-seconds to respond, thus allowing a host controller, such as may be present in a chipset component such as an input/output controller hub (ICH), to dispatch back-to-back commands FISs to various devices. By enabling the host to send CFISs aggressively, the number of actively operating PMPs simultaneously can be maximized, in turn maximizing higher bandwidth utilization of, e.g., a 3 gigabytes per second (Gb/s) host link. Piggy-backing CFISes aggressively on a received or transmitted FIS from the device allows multiple CFIS transmissions in burst mode, thus replenishing the PMPs with commands as quickly as possible and in addition filling the drive's command queue to gain maximum performance from NCQ.

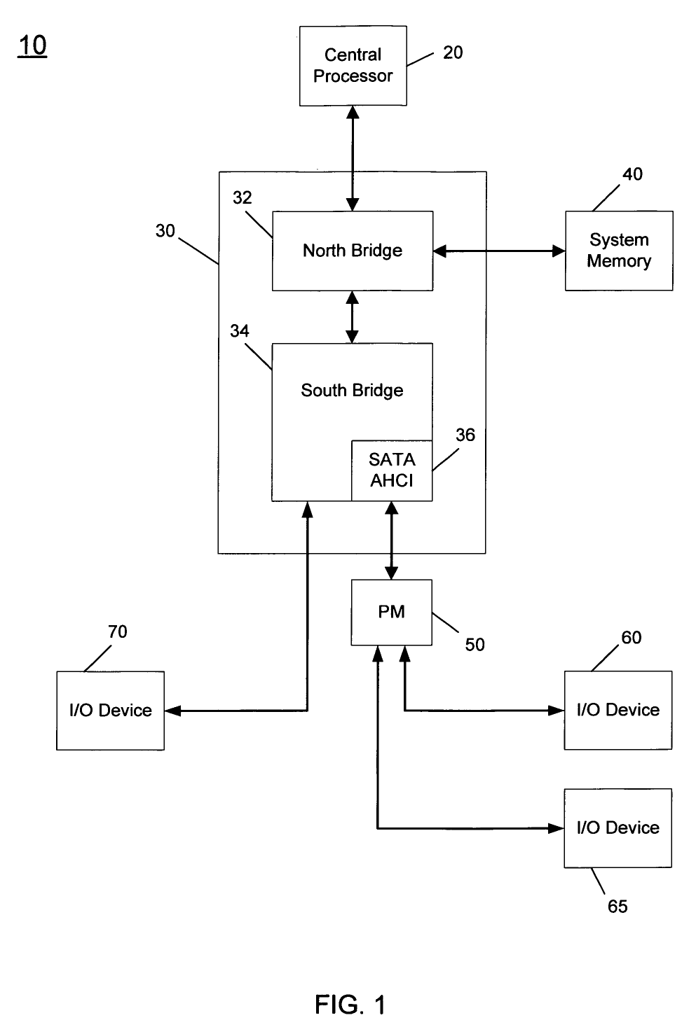

FIG. 1 is a block diagram of a computer system which may be used with embodiments of the present invention. The computer system 10 includes a central processor 20 that is coupled to a chipset 30, which in turn is coupled to a system memory 40. In one embodiment, a system memory controller is located within a north bridge 32 of chipset 30. In another embodiment, a system memory controller is located on the same chip as central processor 20. Information, instructions, and other data may be stored in system memory 40 for use by central processor 20 as well as many other potential devices.

Input/output (I/O) devices, such as I/O devices 60, 65, and 70, are coupled to a south bridge 34 of chipset 30 through one or more I/O interconnects. In one embodiment, the interconnects may be Peripheral Component Interconnect (PCI) interconnects and I/O device 70 is a network interface card. In one embodiment, I/O devices 60 and 65 are SATA devices such as a hard disk, a compact disk (CD) drive, or a digital video disc (DVD) drive. In this embodiment, a SATA host controller 36, which may be in accordance with the SATA Advanced Host Controller Interface (AHCI) rev.1.1 (or another such specification), may be located within chipset 30 and is coupled to a port multiplier 50 behind which I/O devices 60 and 65 are coupled, where the number of I/O devices may comprise 0, 1 or a plurality of I/O devices. In one embodiment, the SATA AHCI 36 is located within south bridge 34 of the chipset 30. Host controller 36 allows I/O devices 60 and 65 to communicate with the rest of the computer system.

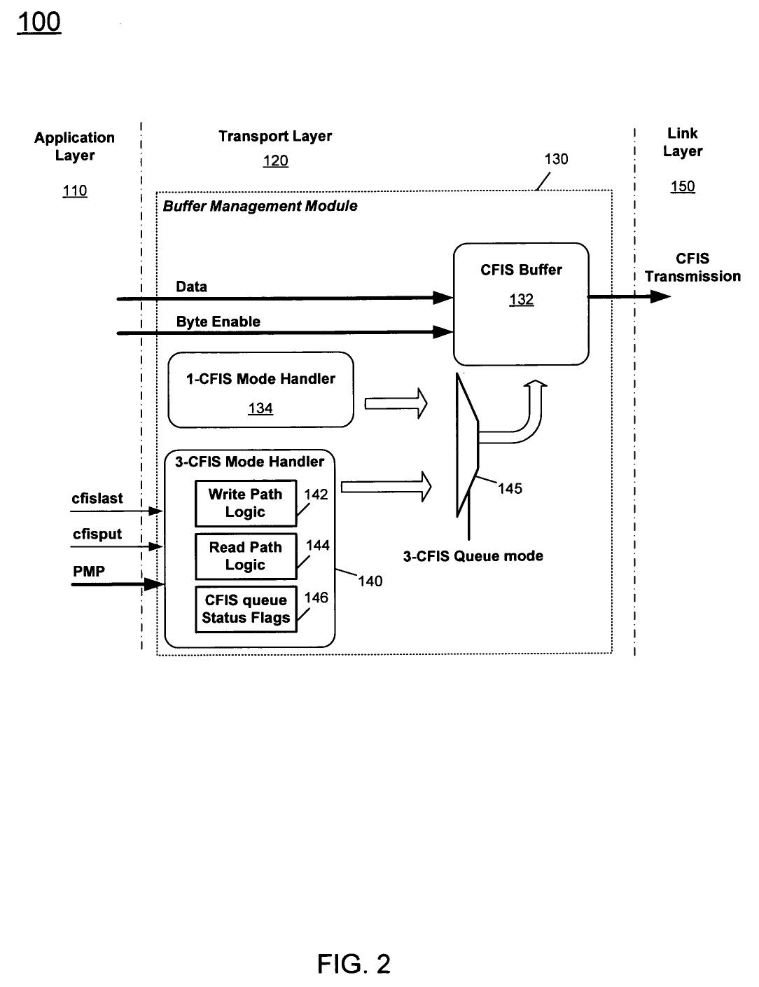

Referring now to FIG. 2, shown is a block diagram of a buffer manager in accordance with one embodiment of the present invention. Such a buffer manager may be located in various portions of a chipset, for example, within a host controller 100 such as an AHCI-compliant controller. As shown in FIG. 2, a transport layer 120 which is coupled between an application layer 110 and a link layer 150 may include a buffer management module 130. Buffer management module 130 may be used to handle control of buffering of command messages in multiple modes of operation, including a conventional mode in which command messages are buffered and transmitted opportunistically, i.e., when available bandwidth exists, and in an aggressive mode, i.e., in a consecutive or back-to-back manner to enable the benefits of NCQ reordering in downstream devices.

As shown in FIG. 2, buffer management module 130 includes a CFIS buffer 132 which, in one embodiment may be a volatile memory such as a dynamic random access memory (DRAM), a static random access memory (SRAM), or another such memory. As shown, incoming data as well as a byte enable signal may be provided as inputs to CFIS buffer 132. In turn, transmission of CFIS messages may be output from buffer 132 to link layer 150. In one embodiment, a maximum of 64 bytes (B) of CFIS buffering may be provided. As the normal CFIS length currently supported is 5 double words (DW), to maximize the effective usage of a 64B CFIS buffer, up to three 5DW-CFISes may be stored at a time, with a restriction of one CFIS per PMP. This enables a host controller to continuously stream out CFISes while masking the fetching latency from system memory with minimal additional hardware.

Buffer management module 130 has 2 modes, 1-CFIS mode and 3-CFIS mode depending on the CFIS length specified in the command list of the command slot. As will be described further below, management of buffer 132 may be controlled by incoming control signals received from a multiplexer 145. As shown in FIG. 2, various information may be provided to an aggressive mode handler 140, also referred to as a 3-CFIS mode handler. Specifically, a CFIS last signal, a CFIS put signal and a PMP signal may be received. These signals correspond to identify the last target DW of a CFIS message, to envelop the duration of CFIS reception from the application layer and an identification tag of an attached target device associated with a command message, respectively. Aggressive mode handler 140 includes write path logic 142, read path logic 146 and CFIS queue status flags 146. Based on the information in CFIS status flags 146, write path logic 142 may control writing of incoming data to CFIS buffer 132 and read path logic 144 may control reading of information within CFIS buffer 132 for a CFIS transmission. Accordingly, the status flags within CFIS queue status flags 146 track the command FIS transmission for the specific PMP so as to ensure the transmission of such command FIS does not violate the SATA command protocols. These flags may be used and updated by write path logic 142 and read path logic 144.

In 3-CFIS queue mode read and write operations to CFIS buffer 132 can be active at the same time, requiring separate buffer-read and buffer-write pointers and an update mechanism to indicate which location within buffer 132 is being read out (for transmission) and which location within buffer 132 is being written (for pending transmission). To handle 3-CFIS queue for FBS, a mechanism may be provided to indicate the number of pending CFISs available in CFIS buffer 132. In the case where a protocol does not allow a transport layer to send a CFIS for the specific PMP, the transport layer can jump to service the next transmittable CFIS.

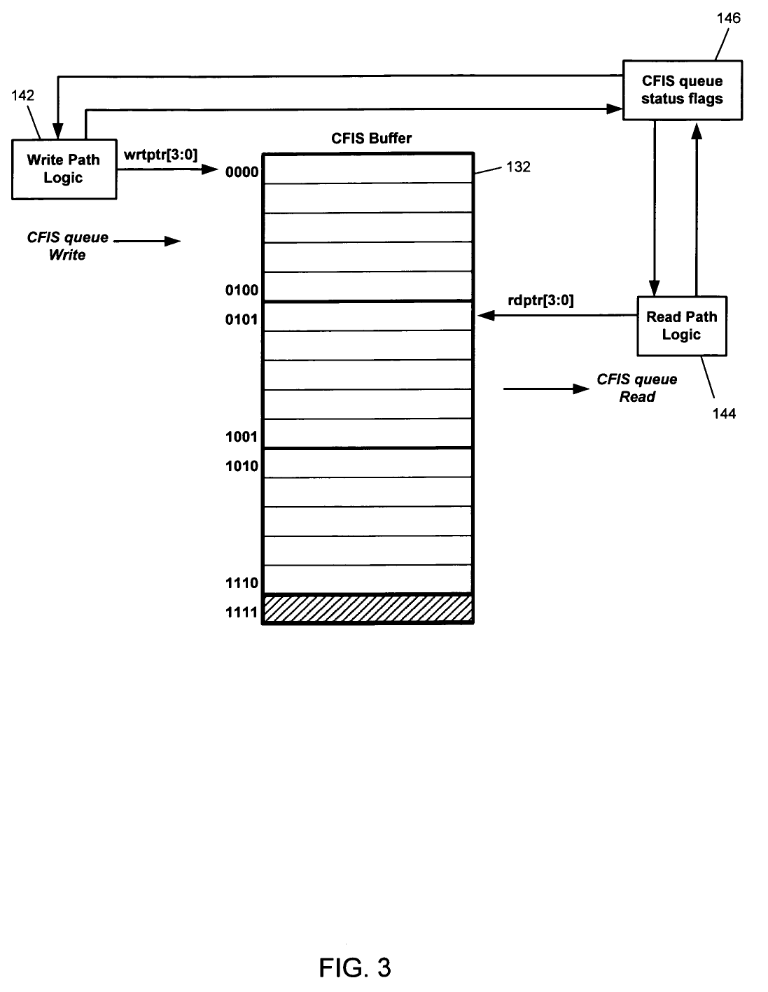

Referring now to FIG. 3, shown is a more detailed block diagram of the interaction between buffer 132 and the various logic and status flags within buffer management module 130. Embodiments provide for an aggressive CFIS mode in which, when there is a valid CFIS in the CFIS buffer and the associated transmission block and passive mode flags are not set, the host can send a CFIS piggy-backed on any of the following FISes: (a) another transmitting CFIS (aggressively or passively); (b) valid transmitted data FIS; or (c) valid received FIS from the device. In one embodiment, the CFIS queue status flags may include a valid flag, a transmission block flag, and a passive mode flag. The valid flag may indicate whether the CFIS queue slot is empty or contains a valid entry. Write path logic 142 will base the CFIS entry on the Valid flag and similarly, read path logic 144 will use the Valid flag to determine if there is a valid CFIS available for transmission. The CFIS transmission block flag indicates whether the CFIS is in a transmittable state for the respective PMP (indicated by PMP holding registers). The CFIS will need to be blocked in natural form if the protocol does not allow the CFIS transmission. In non-NCQ, the natural blockage is terminated only at the end of the data transfer, whereas in NCQ commands, the natural blockage is only when the device is not in a data phase. The CFIS entry can be blocked from transmission even though the CFIS is still valid. Blocked CFISes can conditionally become eligible for being dropped in the transport through a dropping mechanism. As per Port Multiplier specifications, a device can receive error (R_ERR) the CFIS transmission if there is something pending from the device side to be transmitted, thus natural collision can occur within a port multiplier. In this case, the host will retry the CFIS transmission. To avoid a dead-lock for host to lock the SATA link with 1-SYNC, a mechanism to back-off for that PMP may be provided. Specifically, the passive block flag will determine whether the CFIS transmission is to be in aggressive mode or passive (opportunistic) mode. The policy of CFIS transmission chooses the CFIS to be in aggressive mode until a R_ERR is recorded for a CFIS transmission. Upon receiving a R_ERR for the CFIS transmission, the CFIS will remain in passive (opportunistic) mode until any FIS is received from the same PMP. PMP holding registers keep the value of the PMP associated with each CFIS in the queue. The PMP values are needed not only to avoid protocol violation but also to be able to drop the CFIS from the queue using a dropping mechanism or during Single Device Error (SDE) cleanup.

An opportunistic mode handler 134 (i.e., a 1-CFIS mode handler) may be used to handle transmission of CFIS commands in a conventional manner when the ability to aggressively transmit is unavailable. In various embodiments, mode handlers 134 and 140 may be finite state machines (FSMs), although the scope of the present invention is not limited in this regard. While shown with particular implementation in the embodiments of FIGS. 2 and 3, the scope of the present invention is not limited in this regard.

To avoid starving PMPs with outstanding commands, buffer management module 130 will never stall and will always allow CFIS to be sent out as quickly as possible. Buffer management module 130 may dynamically change mode from 3-CFIS mode to 1-CFIS mode by looking at the CFIS length in the command header. The CFIS handling mechanism may handle a single device error (SDE) or host controller error. During the single device error, the cleanup will be specific to the queue location for the PMP with error.

The host may instead operate in an opportunistic or passive CFIS mode if the CFIS being transmitted is R_ERR'ed by the device (which may be due to a Port Multiplier internal FIS collision). The CFIS in passive mode will not attempt to lock the link but rather find natural bandwidth for transmission. CFIS transmission will remain in passive mode until any FIS is received from the corresponding PMP.

To increase effectiveness of having 3-CFISes in the CFIS buffer and to avoid any naturally occurring dead-lock (which can impact performance by starving other PMPs), a dropping mechanism may be implemented in the transport layer which makes it possible for one most recently naturally blocked CFIS to be conditionally dropped from the CFIS buffer thus allowing CFIS for other PMPs to be serviced and transmitted. In one embodiment, the criteria to drop the CFIS may be threefold as listed below. If all the three criteria are met, then the CFIS is dropped, which enables the ICH to stream another CFIS fetch from the memory to back fill the void in CFIS buffer. The criteria, in one embodiment includes: CFIS buffer space should be full (meaning all 3-CFIS locations are occupied); CFIS for all PMPs in the CFIS buffer are in data phase as indicated and thus are blocked for transmission; and there are other PMPs which have outstanding commands to be serviced.

TABLE 1

| | | Passive | |
|---|---|---|---|
| Valid | Transmission | Mode | |
| Flag | Block Flag | Flag | Expected Behavior |
| 0 | 0 | 0 | Valid CFIS is not available in the CFIS |
| | | | location |
| 0 | 0 | 1 | Illegal case should not happen since |
| | | | CFIS queue Valid flag is not set. |
| 0 | 1 | 0 | Illegal case should not happen since |
| | | | CFIS queue Valid flag is not set. |
| 0 | 1 | 1 | Illegal case should not happen since |
| | | | CFIS queue Valid flag is not set. |
| 1 | 0 | 0 | Aggressively transmittable CFIS is |
| | | | available in the CFIS location. |
| 1 | 0 | 1 | Transmittable CFIS is available in the |
| | | | CFIS location but it can be transmitted |
| | | | only in passive (opportunistic) mode. |
| 1 | 1 | 0 | Valid CFIS is available in the CFIS |
| | | | location but the corresponding PMP is in |
| | | | Data Phase. The transmission of this |
| | | | CFIS will be blocked. |
| 1 | 1 | 1 | Illegal case should not happen as |
| | | | Transmission Block and Passive Mode |
| | | | flags can never be set at the same time. |
| | | | When Transmission Block flag is set, |
| | | | transmission is blocked (R_ERR cannot |
| | | | be set). When R_ERR is set and DMAS |
| | | | FIS is received from the corresponding |
| | | | PMP, it will clear the Passive Mode flag |
| | | | due to reception of D2H FIS from the |
| | | | respective PMP. |

Referring now to Table 2, shown is pseudocode in accordance with one embodiment of the present invention.

```
TABLE 2
for (i = 0; i < 3; i++) {
// 1^{st} priority - to find and transmit the CFIS location in aggressive mode
(if any)
  If ((sel_cfisq_cur == xᵢ) && (sel_cfisq_aggr _{any})) {
  // 1^{st} priority is given to the current location in aggressive mode.
    // Subsequently the 2^{nd} and 3^{rd} priority is given to next 2
    locations in sequence.
    If (sel_cfisq_txvalid ᵢ == ‘1’ &&
    sel_cfisq_aggr ᵢ ) {
      sel_cfisq_nxt = xᵢ ;}
    else if (sel_cfisq_txvalid _{(i+1) mod 3} == ‘1’ &&
    sel_cfisq_aggr _{(i+1) mod 3}) {
      sel_cfisq_nxt = x_{(i+1) mod 3} ;}
    else If (sel_cfisq_txvalid _{(i+2) mod 3} == ‘1’ &&
    sel_cfisq_aggr _{(i+2) mod 3}) {
      sel_cfisq_nxt = x_{(i+2) mod 3} ;}
    else {
      sel_cfisq_nxt = xᵢ ;} }
  // 2^{nd} priority - if the CFIS queue is full, then always choose the location
  next in sequence.
Either
  // the CFIS will take the transmission path (opportunistic) or the CFIS
  dropping path.
  else if ((sel_cfisq_cur == xᵢ) && (sel_cfisq_full ₐₗₗ)) {
    If (sel_cfisq_txvalid _{any}) {
      // 1^{st} priority is given to the current location in non-aggressive
transmittable mode. Subsequently
      // the 2^{nd} and 3^{rd} priority is given to next 2 locations in sequence.
      If (sel_cfisq_txvalid ᵢ == ‘1’) {
        sel_cfisq_nxt = xᵢ ;}
    else if (sel_cfisq_txvalid _{(i+1) mod 3} == ‘1’) {
        sel_cfisq_nxt = x_{(i+1) mod 3} ;}
    else If (sel_cfisq_txvalid _{(i+2) mod 3} == ‘1’) {
        sel_cfisq_nxt = x_{(i+2) mod 3} ;}
    else {
        sel_cfisq_nxt = xᵢ ;} }
    else {
    sel_cfisq_nxt = x_{(i+1) mod 3} ;}
  // 3^{rd} priority - in normal operational mode, choose 1^{st} match for
opportunistic CFIS transmission.
  else if (sel_cfisq_xvalid _{(i+1) mod 3} == ‘1’) {
    sel_cfisq_nxt = x_{(i+1) mod 3} ;}
  else if (sel_cfisq_txvalid _{(i+2) mod 3} == ‘1’) {
    sel_cfisq_nxt = x_{(i+2) mod 3} ;}
  else {
    sel_cfisq_nxt = xᵢ ;}
} // End for-loop
```

Thus a host is able to lock a link for transmission by sending a 1-SYNC primitive to the device and then sustaining the X_RDY primitive. As per Port Multiplier specifications, the device will respond to this by sending a receive ready primitive (R_RDY), and if there is any natural FIS transmission collision, it will be resolved by the Port Multiplier sending R_ERR primitive for the corresponding command FIS. Using embodiments of the present invention, a host in FBS mode takes advantage of this process to implement a high performance storage system. More specifically, the host will be able to piggy-back aggressive CFIS(es) right after a transmission/reception of the FIS to/from the Port Multiplier. The Host will engage the link transmission/reception state machine to lock the link by sending a 1-SYNC primitive right after the transmission/reception of the FIS and sustaining XRDY primitive.

The transport layer will indicate to the link layer that an aggressive CFIS is ready to be piggy-backed onto the current FIS in a transaction if any (or all) the CFIS(es) in the CFIS buffer is (are) in aggressive mode. The effect of aggressiveness is engaged if there is at least one CFIS in the CFIS buffer which is in aggressive mode and the link layer transmission/reception state machines are not in an IDLE state. Once the link is locked for CFIS transmission, multiple CFIS(es) from the CFIS buffer can be sent in back-to-back succession before the link lock is released, enabling as many PMPs to be engaged and become active. This algorithm takes advantage of the fact that the transmission time for each CFIS is relatively very short as compared to the response time from the device. The delay in response from the hard disk drive is device specific and the number of devices engaged is application and software dependent.

The following Table 3 shows the criteria to lock the link for CFIS transmission, if a transport layer is indicating aggressive CFIS availability, according to one embodiment.

TABLE 3

| Host Link | Host Link | | |
|---|---|---|---|
| Reception | Transmission | FIS Type in | |
| FSM | FSM | Transmission | Link Layer response |
| IDLE | NON-IDLE | CFIS for | Host Link is currently busy in transmitting |
| | | PMPX is | CFIS for PMP_{X} while transport is |
| | | being | indicating that there is another CFIS for |
| | | transmitted | PMP_{Y} which is in aggressive mode. Link |
| | | | layer will engage the transmission FSM to |
| | | | get response from the device (R_OK or |
| | | | R_ERR), send one SYNC primitive and |
| | | | sustain X_RDY primitive until R_RDY |
| | | | primitive is received from the device. Link |
| | | | layer will then piggy-back the CFIS for |
| | | | PMP_{Y} onto the CFIS for PMP_{X}. |
| IDLE | NON-IDLE | Data for | Host Link is currently busy in transmitting |
| | | PMPX is | Data FIS for PMP_{X} while transport is |
| | | being | indicating that there is another CFIS for |
| | | transmitted | PMP_{Y} which is in aggressive mode. Link |
| | | | layer will engage the transmission FSM to |
| | | | get response from the device (R_OK only), |
| | | | send one SYNC primitive and sustain |
| | | | X_RDY primitive until R_RDY primitive is |
| | | | received from the device. Link layer will |
| | | | then piggy-back the CFIS for PMP_{Y} onto |
| | | | the Data for PMP_{X}. |
| NON-IDLE | IDLE | Data or | Host Link is currently busy in receiving |
| | | RD2H or | (Data or RD2H or PIOS-in or DMAS- |
| | | PIOS-in or | without auto-activate or SDBN or SDB FIS) |
| | | DMAS- | for PMP_{X} while transport is indicating that |
| | | without auto- | there is another CFIS for PMP_{Y} which is in |
| | | activate or | aggressive mode. Host Link Layer will |
| | | SDBN or | engage transmission FSM to send one |
| | | SDBFIS is | SYNC primitive at the first available |
| | | being | opportunity after the host reception FSM |
| | | received. | has sent R_OK to the received FIS and host |
| | | Other FIS | observes a SYNC from the device. Host Link |
| | | from device | will then sustain X_RDY primitive until |
| | | are for Data | R_RDY primitive is received from the |
| | | out. | device. Link layer will then piggy-back the |
| | | | CFIS for PMP_{Y} on to the FIS being received |
| | | | for PMP_{X} from the device. |

The advantage of having commands queued in the drive for NCQ is seen when multiple commands are sent to the device. The device builds the request queue and through its algorithm determines to re-order the commands or not. This is only possible if there are multiple commands queued in the drive. In FBS mode, multiple devices can be active at the same time, but replenishing the command queue for each device with sufficient amount of commands in order to perform optimal command re-ordering is a challenge. If instead only one command at a time is sent due to PMP arbitration, command queuing in the drive is inhibited. In this case, the drive receives only one outstanding command at a time, and only one command at a time is queued, thus no re-ordering can occur and all the benefits of the NCQ will be lost.

In contrast, using embodiments of the present invention in FBS mode, queuing up multiple CFIS for different PMPs and link lock will not only enable multiple commands to queue up in the device for NCQ commands but will also keep most devices active at any given time. Implementing the combination of 3-deep buffering with aggressive transmission mode may provide a performance improvement. Current hard disk drives can take anywhere from few micro-seconds to tens of micro-seconds in completing command dispatching sequence. Embodiments enable the otherwise wasted idle bus bandwidth to be fully consumed by a host with new command dispatching. Thus any theoretical idle time on a bus can be fully taken up by the host as long as there are new commands to be dispatched, greatly increasing bus utilization rates.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
handling a frame information structure (FIS) message at a host controller;
transmitting a synchronization signal from the host controller to a port multiplier coupled to the host controller via a link between the host controller and the port multiplier and sustaining a transmit ready signal from the host controller to the port multiplier after sending the synchronization signal to thereby lock the link; and
transmitting a first command FIS message from the host controller to the port multiplier and a second command FIS message from the host controller to the port multiplier in a back-to-back manner, the first command FIS message for a first device coupled to the port multiplier and the second command FIS message for a second device coupled to the port multiplier.

2. The method of claim 1, further comprising preventing the back-to-back transmission if all command FIS messages pending transmission have a passive mode flag set.

3. The method of claim 2, further comprising switching from transmission of command FIS messages in the back-to-back manner to a single command message transmission mode corresponding to a passive mode based at least in part on the passive mode flag.

4. The method of claim 3, further comprising transmitting the single command message opportunistically during available bandwidth on the link and without locking the link.

5. The method of claim 4, wherein the switching is to occur upon receipt of an error message from the port multiplier or during a transition into a block mode.

6. The method of claim 1, further comprising transmitting a third command FIS message from the host controller to the port multiplier, the third command FIS message for a third device coupled to the port multiplier, the third command FIS message transmitted in the back-to-back manner.

7. The method of claim 1, further comprising dropping a command FIS message from a dispatch command buffer of the host controller if a predetermined portion of the dispatch command buffer is full and all command FIS messages in the dispatch command buffer are blocked due to respective devices coupled to the port multiplier being in a data phase, wherein there is at least one additional command FIS message outstanding in the host controller for a different device coupled to the port multiplier.

8. The method of claim 1, further comprising queuing a plurality of command FIS messages received from the host controller in a queue of the first device and re-ordering at least some of the plurality of command FIS messages in the queue.

9. An apparatus comprising:
a host controller coupled to a port multiplier, wherein the port multiplier is operable to be coupled to a plurality of devices, the host controller including:
a buffer management module to control transmissions from a dispatch command buffer, the buffer management module including a first mode handler, a second mode handler, and a multiplexer coupled to an output of the first mode handler and the second mode handler, the multiplexer to select the first mode handler or the second mode handler to control the dispatch command buffer, wherein the first mode handler is to perform an opportunistic command transmission mode and the second mode handler is to perform an aggressive command transmission mode, the aggressive command transmission mode to transmit a plurality of command messages in a back-to-back manner.

10. The apparatus of claim 9, wherein the dispatch command buffer is to store command messages for the plurality of devices coupled to the port multiplier, the command messages comprising command frame information structure (CFIS) messages.

11. The apparatus of claim 10, wherein the second mode handler includes a write path logic to insert a command message into the dispatch command buffer based on information in a status field, the write path logic to insert the command message at a location pointed to by a write pointer.

12. The apparatus of claim 11, wherein the second mode handler includes a read path logic to read a command message from the dispatch command buffer based on information in the status field, the read path logic to read the command message from a location pointed to by a read pointer.

13. The apparatus of claim 9, wherein the buffer management module is present in a transport layer coupled between an application layer and a link layer of the host controller.
